(19) United States
(12) Patent Application Publication
(10) Pub. No.: US 2005/0117832 A1
(43) Pub. Date: Jun. 2, 2005

(54) Method of improving waveguide bend radius

(76) Inventor: Richard S. Johnston, Sammamish, WA (US)

Correspondence Address: PROCOPIO, CORY, HARGREAVES & SAVITCH LLP, 530 B STREET, SUITE 2100, SAN DIEGO, CA, 92101, US

(21) Appl. No.: 10/954,976

(22) Filed: Sep. 29, 2004

Related U.S. Application Data
(60) Provisional application No. 60/506,962, filed on Sep. 29, 2003.

(51) Int. Cl. G02B 6/12

(52) U.S. Cl. 385/14; 385/32

(57) ABSTRACT

A method of improving the bend radius of a waveguide in a photonic integrated circuit (PIC) while maintaining high PIC to fiber coupling efficiency. The method involves tapering both the width of the waveguide and the index of the waveguide from the coupling region to the region where the waveguide needs to curve.

### RELATED APPLICATION

The present application claims the benefit of priority to U.S. Provisional Patent Application Ser. No. 60/506,962, filed Sep. 29, 2003, and currently co-pending.

### PROBLEM & BACKGROUND

For purposes of this disclosure the waveguide bend radius is the minimum radius that a waveguide can bend while having a constant (but very small such as 0.1 dB) loss. If the bend radius is smaller than the bend radius losses increase. One want very small losses in bends to reduce the overall insertion loss of the PIC device.

The bend radius of the waveguides on a PIC helps determine the overall size of the PIC. A small bend radius results in devices in which the structures in the PIC (couplers, Mach-Zehnder interferometers, etc.) are smaller. The smaller the structures, the smaller and lower cost the device.

Waveguide bend radius is largely determined by the difference in index between the waveguide core and the cladding (this difference is referred to as delta). The larger the delta the smaller the bend radius. Typical single mode fibers have small deltas (0.00 1 is typical) and thus relatively large bend radiuses (several centimeters is common). For single mode propagation within the waveguide the waveguide core diameter is also a function of delta. The smaller the delta the larger the core diameter. Typical single mode fibers in the 1550 nm band have core diameters of 7 to 9 microns.

An additional and potentially major cause of loss in a PIC device is the coupling loss that occurs between the input or output fiber and the waveguides on the PIC. To achieve the smallest coupling loss on wants the diameters of the fibers and the FTC waveguides to be equal. To achieve low coupling loss and single mode propagation in the PIC waveguide this diameter leads to small deltas in the waveguides. These deltas yield waveguides that have larger bend radiuses than desired. Note that, as described in the previous paragraph, a waveguide that has a diameter that matches fiber but a larger delta will allow propagation of more than one mode which is not desired.

What is needed is a method of forming waveguides on PICs that achieve low coupling losses and small bend radiuses. This disclosure describes a method of meeting these goals.

### INVENTION DESCRIPTION

This invention was developed for Comp-Optics sol-gel waveguide creation process. In this process a layer of sol-gel is deposited creating the waveguide layer. The nominal index of the layer is that of the cladding material. When exposed to ultraviolet (UV) illumination the index of the material increases. Waveguides are created by exposing (through laser drawing or mask projection) the waveguides to UV illumination (this is followed by a stabilization step), the cladding areas are not exposed. The delta created during this exposure is related to the amount of exposure. The greater the exposure the greater the index increase. Note that while the invention is described in terms of the above process it is equally applicable to any process that allows the waveguide index to be continuously varied along the length of the waveguide.

In order to achieve good fiber to waveguide coupling the UV exposure level (and hence delta) and waveguide width are selected such that the PIC waveguide closely matches that of fiber. As the PIC waveguide advances in this invention the width is gradually reduced and the exposure level (and delta) increased. The taper in width and delta should be a continuous function until the desired width and delta are achieved. The waveguide is typically straight during the taper region. After the taper the high delta waveguide will have a reduced bend radius was compared to the pre-tapered waveguide. After all functions have been performed the reverse tapers are applied to the waveguides before coupling to output fibers.

In Comp-Optics sol-gel process waveguides are written using a laser drawing system or through a mask projection process. To achieve the desired exposure tapers with the laser drawing system either the laser drawing speed can be reduced (for increased exposure) or the laser intensity can be increased. When devices are fabricated with a mask projection process a gray scale mask can be used to taper exposure level.

1. A method of bending an optical fiber to improve coupling characteristics, comprising the steps of:
selecting a waveguide width that closely matches the width of a fiber; and
placing said fiber adjacent said waveguide to establish optical coupling therebetween.
